(19) United States
(12) Patent Application Publication
(10) Pub. No.: US 2018/0232750 A1
(43) Pub. Date: Aug. 16, 2018

(54) SYSTEMS AND METHODS FOR PREDICTING CUSTOMER BEHAVIOR FROM SOCIAL MEDIA ACTIVITY

(71) Applicant: Wal-Mart Stores, Inc., Bentonville, AR (US)

(72) Inventors: Winston Spencer, Bentonville, AR (US); Michael Lawerance Payne, Centerton, AR (US); Yong Joon Lee, Rogers, AR (US)

(21) Appl. No.: 15/880,782

(22) Filed: Jan. 26, 2018

Related U.S. Application Data
(60) Provisional application No. 62/458,274, filed on Feb. 13, 2017.

(51) Int. Cl. G06Q 30/02; G06Q 50/00

(52) U.S. Cl. CPC G06Q 30/0202; G06Q 50/01

(57) ABSTRACT

Systems and methods for aggregating customer social media and transaction data and using the aggregated data to predict future customer behavior are disclosed. In embodiments, social media messages are matched to customer profiles by attempting to match a social media identifier attribute to a set of social media identifiers of a stored customer profile in a customer database, or attempting to match other profile information. If no matches are found, a new customer profile can be created and stored based on the social media message. In embodiments, one or more scores are calculated based on the known behavior of a set of similar customers determined from the customer database and the transaction database. Similar customers can include customers with similar demographic information, location, or customers that have expressed interest in similar products. The one or more scores are stored in a score database in embodiments, for access by prediction consumption systems.

### RELATED APPLICATION

The present application claims the benefit of U.S. Provisional Application No. 62/458,274 filed Feb. 13, 2017, which is hereby incorporated herein in its entirety by reference.

### TECHNICAL FIELD

Embodiments of the present disclosure relate generally to predicting customer behaviors, and more particularly to predicting customer behaviors based on expressed preferences.

### BACKGROUND

Manufacturers and retailers of consumer products can make purchasing, pricing, marketing or other decisions based on predictions of customer behavior. For example, customer behavior can be predicted based on demographics or previous purchases. These predictions can be tied to a customer profile based on information that the customer has provided to the retailer or associated information. For example, when a credit card purchase is made, the retailer can associate the cardholder's name and the credit card information with a customer profile. Given the name, the retailer may be able to infer other profile information such as the customer's phone number or address.

Social media services, such as Twitter, Facebook, Google Plus, and others, allow consumers to express interest in a variety of topics, including products via mechanisms to “Like,” “Favorite,” “Love,” “Follow” or “Share” posts and internet sites related to the product. While some social media users are likely to express interest in products that they intend to buy, others may express interest but not have the intention or the means to purchase the product.

### SUMMARY

Embodiments of the present disclosure include systems and methods for aggregating customer social media and transaction data and using the aggregated data to predict future customer behaviors.

In an embodiment, a system for predicting customer behavior based on a customer profile query comprising one or more attributes comprises a customer database that stores customer profiles and associated attributes, an item database that stores items and social media product identifiers, a transaction database that stores transactions and associated items and customer profiles, a score database that stores predictions of customer behavior, a file input processor that receives social media messages, a customer matching engine that matches social media messages with customer profiles, and a scoring model engine that uses the customer profile, item information, and stored scores to calculate a score related to the likelihood that the customer associated with the social media message will purchase the item.

In embodiments, social media messages are matched to customer profiles by attempting to match a social media identifier attribute to a set of social media identifiers of a stored customer profile in the customer database, attempting to match an email address associated with the message or the device to an email address attribute of a stored customer profile, attempting to match a phone number associated with the message or the device to a phone number attribute of a stored customer profile, and attempting to match a location associated with the message or the device with the home address attribute or home internet protocol address attribute of a stored customer profile. The social media identifier and other information in the social media message can be stored in the customer profile if a match is found. If no matches are found, a new customer profile can be created and stored based on the social media message.

In embodiments, one or more scores are calculated based on the known behavior of a set of similar customers determined from the customer database and the transaction database. Similar customers can include customers with similar demographic information, location, or customers that have expressed interest in similar products. The one or more scores are stored in a score database in embodiments, for access by prediction consumption systems.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a block diagram depicting various components of a customer behavior prediction system 100 according to an embodiment.

FIG. 2A is a schematic diagram depicting attributes of a customer profile according to an embodiment.

FIG. 2B is a schematic diagram depicting attributes of a social media message according to an embodiment.

FIG. 3 is a flowchart depicting a method for associating a social media message with a customer profile according to an embodiment.

FIG. 4 is a flowchart depicting a method for determine and storing a score according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

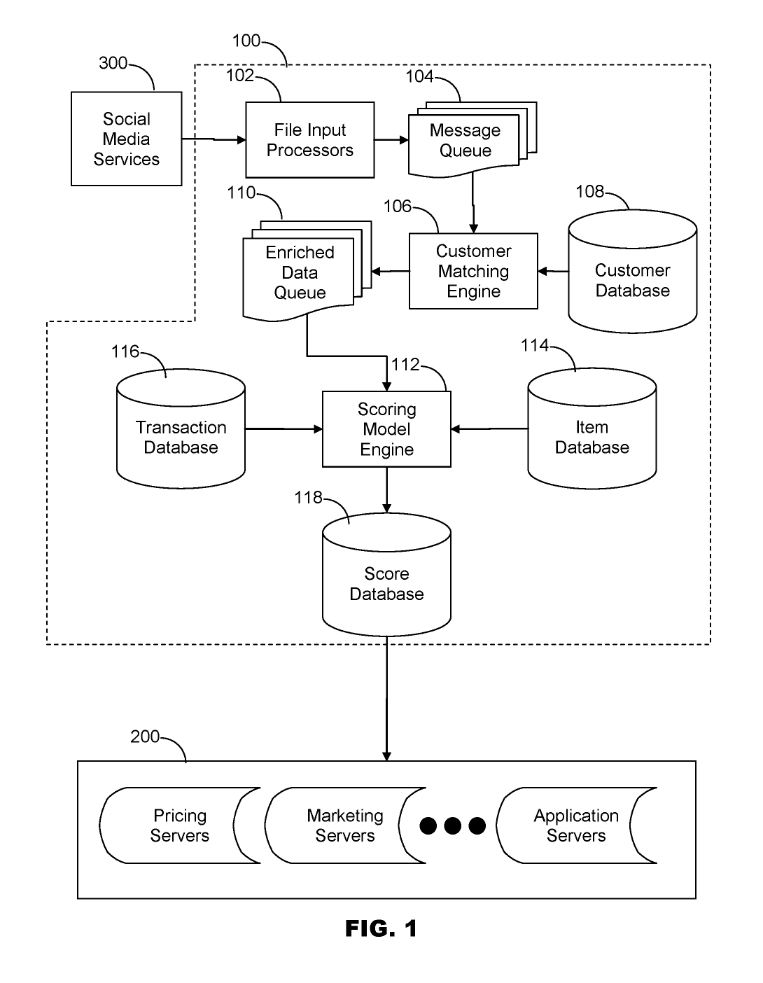

FIG. 1 is a block diagram depicting various components of a customer behavior prediction system 100 according to embodiments of the present disclosure. According to embodiments, predictions related to the likelihood of a specific customer performing a behavior (such as purchasing a product after indicating interest in the product via social media) can be determined based on, at least in part, the behavior of customers having similar attributes. These predictions can be accessed and utilized by various prediction consumption systems 200, such as pricing systems, marketing systems, application systems or other systems. The predictions can also be provided to a user via a user interface (not shown) of a type known in the art, in embodiments.

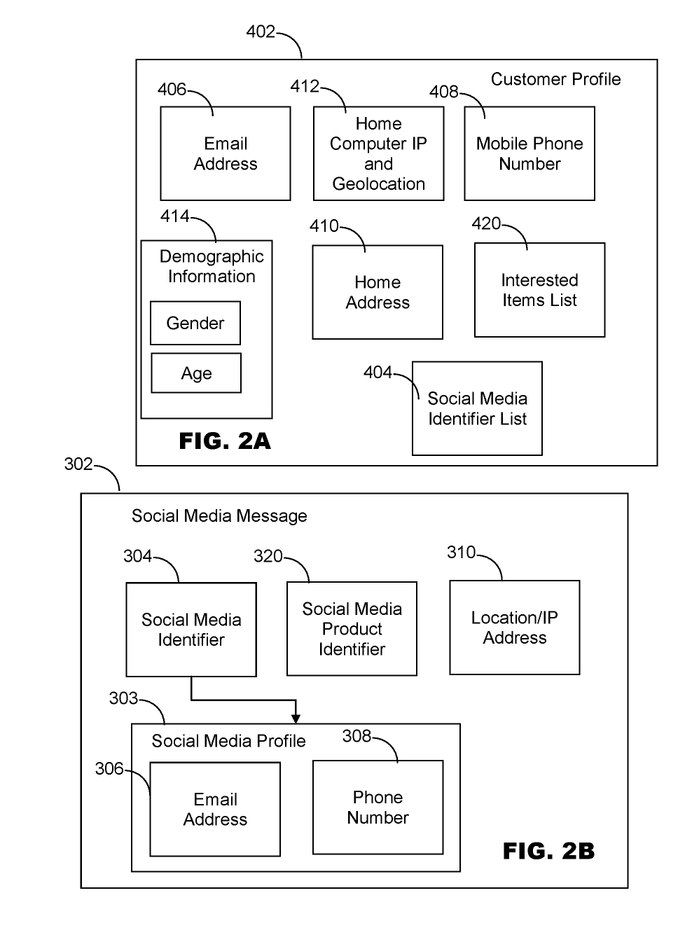

According to embodiments, file input processors 102 receive or otherwise obtain social media messages 302 (depicted in FIG. 2) from social media services 300. Social media services 300 can include any social media service such as Facebook, Twitter, Google Plus, Pinterest, or some other social media service or other source of customer preference data. File input processors 102 can be configured to interface with application programming interfaces (APIs) provided by social media services 300 for data access in real time or in batches. File input processors 102 can also be configured to monitor and receive public data provided by social media services 300 in real time. File input processors can also be configured to receive data via other input methods such as secure file transfer protocol, physical media or direct data entry in embodiments. In embodiments, file input processors provide social media messages 302 to a message queue 104 for processing. In embodiments, file input processors 102 can request additional data from social media services 300 or other data sources as necessary for storage of each social media message 302. In embodiments, file input processors 102 can clean, trim, or otherwise manipulate the data provided by social media services 300 to create social media messages 302.

In embodiments, one or more customer matching engines 106 processes each social media message 302 in message queue 104 and matches the message 302 with an existing customer profile 402 in a customer database 108, if possible. In embodiments, if no match is found, customer matching engines 106 can create and store a new customer profile 402 in the customer database. FIG. 2A is a block diagram depicting attributes of an example customer profile 402 according to an embodiment. In embodiments, customer profiles 402 can include one or more social media identifiers stored in social media identifier list 404. Customer profile 402 can further include identifying information such as customer email address 306, mobile or home phone number 408, home address 410, and home computer internet protocol address (IP address) and associated geolocation information 412. In embodiments, customer profile 402 can further include demographic information 414 such as age, gender, household income, occupation, or other demographic information of interest. In embodiments, customer profile 402 can include an interested items list 420, comprising items or item identifiers that the customer associated with customer profile 402 has expressed interest in through social media or other means. In embodiments, each customer profile 402 may include more than a single instance of any attribute (for example, a customer may have multiple phone numbers or IP addresses). In embodiments, customer profiles 402 may include more, fewer, or alternate attributes to those discussed herein. In embodiments, customer profiles 402 can be populated based on information directly provided to a retailer or manufacturer, or can be received from or augmented by data provided by third party public records or other databases.

FIG. 2B is a block diagram depicting attributes of an example social media message 302. In general, social media message 302 can include a social media identifier 304 such as a social media user name or handle. Social media message 302 can further include information that can be linked to a social media profile 303, such as one or more email addresses 306 or phone numbers 308. Social media message 302 can further provide location information 310, such as a social media home address, a current location as reported by a mobile or other device, or a an originating IP address of the social media message. Social media message 302 further includes one or more product identifiers 320. Product identifiers 320 can be links to uniform resource locators (URLs) or other internet links to information for a product, product names, product model numbers, product photos, bar codes, or any other text or data that can be linked with a specific product. In embodiments, social media message 302 and social media profile 303 can include more than a single instance of any attribute. Further, the contents of social media message 302 and social media profile 303 can vary based on the information that is provided by each social media service 300. In embodiments, social media message 302 can include less information than is provided by each social media service 300. In embodiments, some or all attributes of social media message 302 and social media profile 303 can be received from or augmented by data provided by third party public records or other databases. In embodiments, each social media message 302 may include more than a single instance of any attribute. In embodiments, a location attribute can be determined from the message, the device, or from the location of one or more device detecting beacons that the device is within range of.

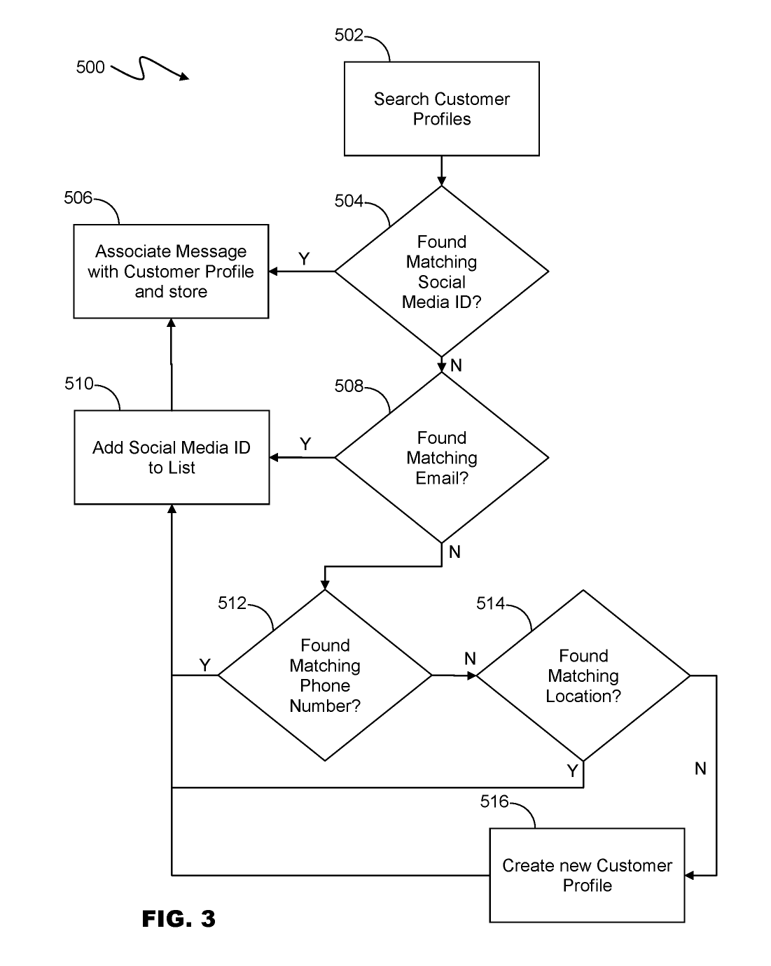

FIG. 3 is a flowchart depicting a method 500 that can be implemented by customer matching servers 106 in embodiments in order to associate a social media message 302 stored in the message queue 104 with a customer profile 402 stored in customer database 108 according to embodiments. At 502, the social media message is examined for identifying attributes and compared to customer profile data 402 stored in customer database.

At 504, if the social media identifier 304 is found in a social media identifier list 404 of a customer profile, the message can be associated with the customer profile 506. At 508, if an email address 306 associated with the social media message 302 matches a customer email address 406, the social media identifier 304 can be added to the social media identifier list 404 of the customer profile 402 at 510 and the message 302 can be associated with the customer profile at 506. Similarly, at 512 if a phone number 308 associated with the message 302 matches a phone number of a customer profile 308, the social media identifier 304 can be added to the social media identifier list 404 of the customer profile 402 at 510 and the message 302 can be associated with the customer profile at 506.

In embodiments, customer matching services 106 can infer customer identification based on location information 310 associated with social media message 302 at 514. For example, the if the IP address or geolocation information associated with social media message 302 matches or is sufficiently close to that of an existing customer profile 402, the social media identifier can be added to the social media identifier list at 510, and the message can be associated with the existing customer profile 506.

If no match is found, the customer matching server 106 can create a new customer profile at 516, and associated the social media identifier at 510 and the social media message at 506 with the new customer profile 402.

In embodiments, matches can be evaluated exactly, or based on fuzzy or other criteria. For example, customer matching server 106 can infer a customer identification based on closely matching phone numbers, locations, or other attributes in embodiments. In embodiments, customer matching server 106 can use a combination of closely matched attributes in order to determine a customer identification. In embodiments, customer matching server 106 can match customer attributes in any order, and can use more attributes than those discussed here, provided the data is available, or can ignore one or more attributes of social media message 302 and customer profile 402. In sum, method 500 makes an educated guess at associating a social media message 302 with a customer profile 402 based on the available data attributes. In embodiments, any updates to customer profile 402 can be stored in customer database 108.

After association with a customer profile at 506, the combined social media message and customer profile 402 are stored in an enriched data queue for processing by scoring model services 110 (see FIG. 1) in embodiments. In embodiments, scoring model servers 110 can query item databases 114 and transaction databases 116. In embodiments, item database 114 can store data necessary to associate one or more social media product identifiers 320 with one or more items. In embodiments, transaction databases 116 can store data required to determine when and if a customer associated with a given customer profile 402 has ever purchased an item. In embodiments, transaction database 116 can store more data, such as purchase price, purchase location, other items purchased, payment methods, and the like.

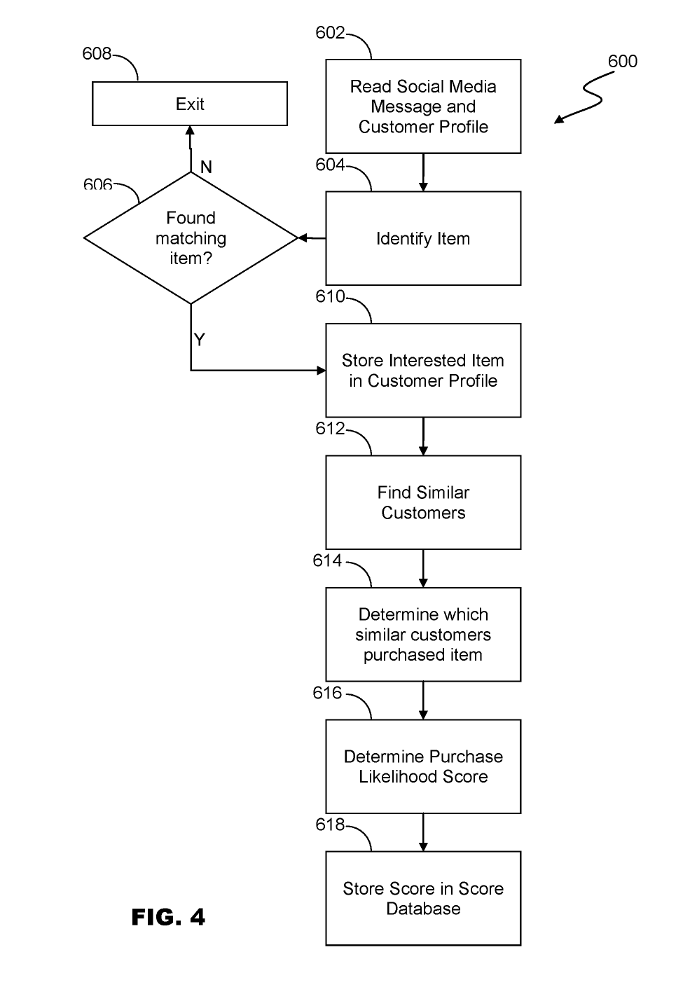

FIG. 4 is a flowchart depicting a method 600 for calculating a score related to the likelihood of the customer associated with the social media message 302 performing an action, such as purchasing a product in which they have previously expressed interest. At 602, the combined social media message 302 and customer profile 402 are read from the enriched data queue 110.

In embodiments, scoring model engine 112 can attempt to match each social media product identifier 320 in social media message 302 with one or more items in item databases 114 at 604. As with customer matching, item matching can be exact or include partial or fuzzy match criteria. In embodiments, items in item databases 114 can be stored with one or more associated known social media product identifiers, for example, a photograph of the product, a model number, a bar code, etc. At 606, if no matching item is found, method 600 can end at 608. If a matching item is found, an identifier for the item can be stored in the interested items list 420 of customer profile 402 at 610.

At 612, a set of one or more similar customers can be determined from customer database 108. In embodiments, criteria for determining customer similar can be based on one or more of demographic information 414, similar location information 412, and/or similar lists of interested items 420. In embodiments, similar customers can be restricted to those that have also expressed interest in the same item associated with social media product identifier 320. In other embodiments, interest in similar items can be used as the criteria. More or fewer criteria for selecting similar customers can be used in embodiments.

At 614, transactions database 116 can be queried to determine which of the similar customers eventually purchased the item associated with social media product identifier 320. In embodiments, exact matches can be used. In other embodiments, purchases of similar items can be considered.

At 616, a score indicating the likelihood of the customer associated with customer profile 402 purchasing an item associated with social media product identifier 320 is calculated. In embodiments, the score can be equivalent to the percentage of similar customers that purchased the item (or similar items), though other score calculations can be used. In embodiments, the score can incorporate demographic information 414, transaction information such as the purchase date and/or purchase price, or other data associated with customer profile 402, the profiles of similar customers, and the transactions associated with the item or similar items. In embodiments, a plurality of scores can be stored for each item. For example, a score related to the likelihood of purchasing the item at full price and at various sale prices can be stored.

At 618, the score is stored in score database 118. The score database 118 can store a plurality of scores associated with a customer profile 402 and an item, or social media product identifier 320. Score database can provide scores and associated information to the prediction consumption systems 200.

In embodiments, one prediction consumption system 200 can be a marketing application, configured to generate customer communications including offers, coupons, or sale notices. For example, the marketing application can use the customer information and scores to produce communications that highlight items that have high scores associated with a particular customer (or group of customers). Therefore, if a customer “likes” an item on a social media service, the marketing application can choose to send that customer a coupon for that item, if the customer is unlikely to purchase it, or may send a communication simply describing the item if the customer scored as likely to purchase it. Other prediction consumption systems can use the scores in different ways and for different purposes, such as determining appropriate pricing within a market, or making decisions regarding the number of items to order for inventory.

In embodiments, customer behavior prediction system 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In embodiments, the system or components thereof can comprise or include various modules, processors, or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In embodiments, each of customer database 108, item database 114, transaction database 116 and score database 118 may be relational databases with tabular structures, or NoSQL or other non-relational databases with key-value, grid, or other structures. Databases 108, 114, 116, and 118 provide storage for one or more data items. Data items can include individual cells or fields, rows, tables, key-value pairs, or entire databases. In embodiments, the stored data items can be divided into groups based on criteria such as the values of subcomponents of each data item. Each stored data item can be held in one or more containers within databases 108, 114, 116, and 118. Each of message queue 104 and enriched data queue 110 can comprise databases, or other data storage structures appropriate for storing data awaiting processing.

In embodiments, databases 108, 114, 116, and 118 can be provided with the various engines of customer behavior prediction system 100. In alternate embodiments, any of databases 108, 114, 116, and 118 can be provided externally to system 100, such that each database 108, 114, 116, and 118 as described herein represents a data connection to a separate data store, accessible by system 100 for data retrieval and storage as described herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for predicting customer behavior based on a customer profile query comprising one or more attributes, the system comprising:
a customer database server configured to store one or more customer profiles each comprising one or more attributes;
an item database server configured store one or more items each optionally having at least one social media product identifier;
a transaction database server configured to store one or more transactions each associated with a customer profile and at least one item;
a score database configured store one or more scores associated with customer profiles and to provide a prediction of customer behavior based on the scores associated with one or more customer profiles that correspond to the customer profile query;
a file input processor configured to receive a message sent by a device from a source social media system and including a social media identifier and a social media product identifier and to store the message in a message queue;
a customer matching server configured to receive each message in the message queue to associate the message with a customer profile, and to store the customer profile and the message in an enriched customer data queue; and
a scoring model server configured to:
receive each customer profile and message in the enriched customer data queue,
identify an item in the item database server having the social media product identifier,
store a record related to the item as an attribute of the customer profile in the customer database server,
determine a set of one or more similar customer profiles in the customer database server, each having a record related to the item as an attribute and being associated at least one transaction in the transaction database server,
calculate a score related to the likelihood that the customer represented by the customer profile will exhibit a behavior based on whether each of the one or more similar customer profiles is associated with at least one transaction associated with the item, and
store the score in a score record in the score database, the score record associated with the customer profile and the item whereby the score can be retrieved based on one or more attributes of the customer profile or the item.

2. The system of claim 1, wherein the file input processor is further configured to:
retrieve a social media profile associated with the social media identifier from the source social media system, the social media profile including one or more social media attributes, each of the one or more social media attributes being selected from the group including: email address, phone number, and location; and
store the social media attributes in the message queue with the message.

3. The system of claim 2, wherein one of the one or more social media attributes is a location attribute and wherein the file input processor is further configured to receive the location attribute from the device.

4. The system of claim 2, wherein one of the one or more social media attributes is a location attribute and wherein the file input processor is further configured to determine the value of the location attribute based on the location of one or more beacons that have detected the device.

5. The system of claim 2, wherein:
the attributes of the customer profile further comprise at least one of an email address, a home internet protocol address, a home address, a phone number, and a set of social media identifiers; and
wherein the customer matching server associates the social media message with a customer profile by:
attempting to match the social media identifier attribute to a set of social media identifiers of a stored customer profile in the customer database,
attempting to match an email address associated with the message or the device to an email address attribute of a stored customer profile and storing the social media identifier in the set of social media identifiers of the stored customer profile if a match is found,
attempting to match a phone number associated with the message or the device to a phone number attribute of a stored customer profile and storing the social media identifier in the set of social media identifiers of the stored customer profile if a match is found,
attempting to match a location associated with the message or the device with the home address attribute or home internet protocol address attribute of a stored customer profile and storing the social media identifier in the set of social media identifiers of the stored customer profile if a match is found, and
if no matches are found, storing a new customer profile in the customer database server and storing the social media identifier in the list of social media identifiers of the new customer profile.

6. The system of claim 1, wherein each customer profile further comprises a customer age attribute and a customer gender attribute; and
further wherein the scoring model server determines a set of one or more similar customer profiles by:
reviewing one or more stored customer profiles in the customer database, and
adding a stored customer profile to the set of similar customer profiles if the stored customer profile matches the customer profile based one or more attributes selected from the set including customer age attribute, customer gender attribute, home address attribute, or home internet protocol address attribute.

7. The system of claim 1, wherein the scoring model server calculates a score related to the likelihood that the customer represented by the customer profile will exhibit the behavior based also on a value associated with the source social media system.

8. The system of claim 1, wherein the file input processor is further configured to receive the message from the source social media system via a secure file transfer protocol connection.

9. The system of claim 1, wherein the file input processor is further configured to receive the message within a batch of messages provided by the source social media system.

10. The system of claim 1, further comprising a marketing server configured to
retrieve one or more score records from the score database associated with a customer profile and having a score above a threshold; and
generate a marketing message for communication to the customer associated with the customer profile, the marketing message including information related to an item associated with at least one of the one or more retrieved score records.

11. A method for predicting customer behavior based on a customer profile query comprising one or more attributes, the method comprising:
receiving a message sent by a device from a source social media system and including a social media identifier and a social media product identifier and storing the message in a message queue;
associating each message in the message queue with a customer profile having one or more attributes in a customer database;
determining an item associated with each message based on the social media product identifier;
storing a record related to the item associated with each message as an attribute of the customer profile in the customer database;
determining a set of one or more similar customer profiles for each message, each similar customer profile having a record related to the item as an attribute;
calculating a score related to the likelihood that the customer represented by the customer profile associated with each message will exhibit the behavior based on whether each of the similar customer profiles is associated with at least one transaction associated with the item;
storing the customer profile and the score associated with each message in a score database whereby the score can be retrieved based on one or more attributes of the customer profile; and
providing a prediction of customer behavior based on the scores in the score database associated with one or more customer profiles that correspond to the customer profile query.

12. The method of claim 11, further comprising:
retrieving a social media profile associated with the social media identifier from the source social media system, the social media profile including one or more social media attributes, each of the one or more social media attributes being selected from the group including: email address, phone number, and location; and
store the social media attributes in the message queue with the message.

13. The method of claim 12, wherein one of the one or more social media attributes is a location attribute and wherein the location attribute is received from the device.

14. The method of claim 12, wherein one of the one or more social media attributes is a location attribute and wherein the value of the location attribute is determined based on the location of one or more beacons that have detected the device.

15. The method of claim 12, wherein:
the attributes of the customer profile further comprise at least one of an email address, a home internet protocol address, a home address, a phone number, and a set of social media identifiers;
and wherein associating each message in the message queue with a customer profile in a customer database comprises:
attempting to match the social media identifier attribute to a set of social media identifiers of a stored customer profile in the customer database,
attempting to match an email address associated with the message or the device to an email address attribute of a stored customer profile and storing the social media identifier in the set of social media identifiers of the stored customer profile if a match is found,
attempting to match a phone number associated with the message or the device to a phone number attribute of a stored customer profile and storing the social media identifier in the set of social media identifiers of the stored customer profile if a match is found,
attempting to match a location associated with the message or the device with the home address attribute or home internet protocol address attribute of a stored customer profile and storing the social media identifier in the set of social media identifiers of the stored customer profile if a match is found, and
if no matches are found, storing a new customer profile in the customer database and storing the social media identifier in the list of social media identifiers of the new customer profile.

16. The method of claim 11, wherein each customer profile further comprises a customer age attribute and a customer gender attribute, and wherein determining a set of one or more similar customer profiles comprises:
reviewing one or more stored customer profiles in the customer database, and
adding a stored customer profile to the set of similar customer profiles if the stored customer profile matches the customer profile associated with the message based one or more attributes selected from the set including customer age attribute, customer gender attribute, home address attribute, and home internet protocol address attribute.

17. The method of claim 11, wherein calculating a score related to the likelihood that the customer represented by the customer profile associated with each message will exhibit the behavior is also based on a value associated with the source social media system.

18. The method of claim 11, wherein the message is received from the source social media system via a secure file transfer protocol connection.

19. The method of claim 11, wherein the message is received within a batch of messages provided by the source social media system.

20. The method claim 11, further comprising:
retrieving one or more score records from the score database associated with a customer profile and having a score above a threshold; and
generating a marketing message for communication to the customer associated with the customer profile, the marketing message including information related to an item associated with at least one of the one or more retrieved score records.
